(19) United States
(12) Patent Application Publication
(10) Pub. No.: US 2016/0102562 A1
(43) Pub. Date: Apr. 14, 2016

(54) COOLING ARRANGEMENT FOR GAS TURBINE BLADE PLATFORM

(71) Applicant: SIEMENS ENERGY, INC., Orlando, FL (US)

(72) Inventors: Charles M. Evans, Tequesta, FL (US); Andrew R. Narcus, Loxahatchee, FL (US); Robert J. McClelland, Palm City, FL (US); Frank Moehrle, Palm City, FL (US)

(73) Assignee: Siemens Energy, Inc., Orlando, FL (US)

(21) Appl. No.: 14/890,925

(22) PCT Filed: May 20, 2014
(86) PCT No.: PCT/US2014/038755

§ 371 Date: Nov. 13, 2015

Related U.S. Application Data
(60) Provisional application No. 61/825,602, filed on May 21, 2013.

(51) Int. Cl. F01D 5/18

(52) U.S. Cl. CPC F01D 5/186; F05D 2260/202

(57) ABSTRACT

A gas turbine engine blade (10), having: an airfoil (12) having a pressure side (22) and a suction side (24); an inner platform (30), having: a gas path surface (40); a coolant surface (42); and at least one row (114) of film cooling holes (112) spanning there between and disposed on the pressure side of the airfoil. The film cooling holes are angled to include a directional component substantially parallel with the pressure side at a trailing end of the airfoil, and the at least one row is oriented substantially parallel to a mateface wall (122) of the inner platform. An array (130) of turbulators (132) is disposed on the coolant surface.

This application claims benefit of the 21 May 2013 filing date of US. provisional patent application No. 61/825,602, which is incorporated by reference herein.

### FIELD OF THE INVENTION

The invention relates to a gas turbine engine blade having an inner platform cooling system.

### BACKGROUND OF THE INVENTION

Gas turbine engines impart rotation to a shaft by combusting fuel and directing hot gases onto an airfoil portion of a blade that extends into the hot gas path. The airfoil is secured to a platform that is, in turn, affixed to the shaft. The platform has a hot gas surface partly bounding the hot gas path and a coolant side exposed to a flow of cooling fluid. Thus, from a base of the blade, to the platform, to the airfoil, to a tip, the blade experiences a wide range of temperatures, and one of the greatest temperature gradients and resulting high thermal stress patterns occurs through the inner platform. Consequently, the platform can experience a large thermal differential with the blade airfoil and resulting high operating stress levels. Cooling the platform is therefore extremely important, and any improvement can contribute to a life of the platform, and therefore the blade.

### BRIEF DESCRIPTION OF THE DRAWINGS

The invention is explained in the following description in view of the drawings that show:

FIG. 1 shows a blade incorporating an exemplary embodiment of the cooling system disclosed herein.

FIG. 2 shows a gas path surface side of the platform film cooling arrangement.

FIG. 3 shows a coolant surface side of the platform film cooling arrangement, a turbulator arrangement, and an inlet side of a mateface cooling arrangement.

FIG. 4 shows the platform film cooling arrangement through the inner platform as well as the turbulator arrangement.

FIG. 5 is another view of the platform film cooling arrangement, and a partial view of a mateface wall cooling arrangement.

FIG. 6 shows an outlets side of the mateface cooling arrangement and a portion of the mateface wall cooling arrangement.

### DETAILED DESCRIPTION OF THE INVENTION

The present inventors have devised a cooling system that includes several cooling arrangements that work together to effectively cool an inner platform of a gas turbine engine blade.

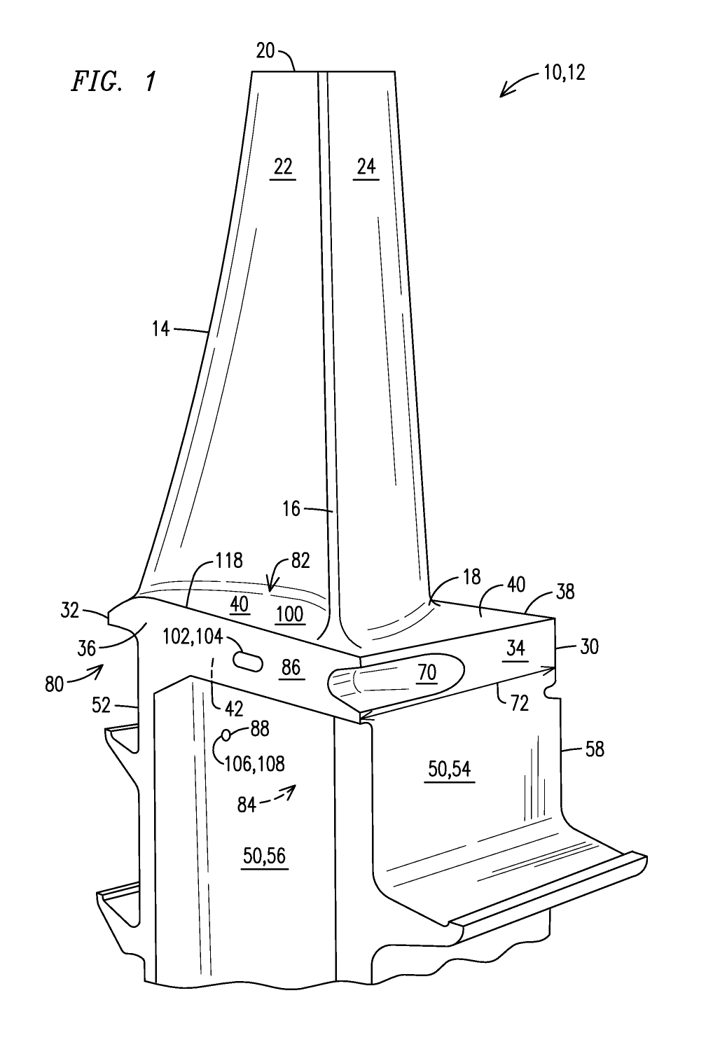

FIG. 1 shows a gas turbine engine blade 10 having an airfoil 12 with a leading edge 14, a trailing edge 16, a base 18, a tip 20, a pressure side 22, and a suction side 24. The airfoil 12 is secured to an inner platform 30 having a platform forward face 32, a platform aft face 34, a platform pressure side face 36 also known as a mateface 36, a platform suction side face 38, a platform gas path surface 40 and a platform coolant surface 42. The inner platform 30 lies between the airfoil 12 and a shank 50, which has a shank forward face 52, a shank aft face 54, a shank pressure side face 56, and a shank suction side face 58. A trailing edge undercut 70 is formed into the inner platform 30, across the platform aft face 34 between the mateface 36 and the platform suction side face 38. In the exemplary embodiment shown, the trailing edge undercut 70 spans from the mateface 36 approximately half of a width 72 of the platform aft face 34.

Also visible are portions of various arrangements that make up a platform cooling system 80, which includes a platform film cooling arrangement 82, a turbulator arrangement 84 (not visible in this figure), a mateface cooling arrangement 86, and a mateface wall cooling arrangement 88. Specifically, a gas path side 100 of the platform film cooling arrangement 82 is visible, as is a mateface purge slot outlet 102 of a mateface purge slot 104 of the mateface cooling arrangement 86, and a shank outlet 106 of a shank cooling hole 108 of the mateface wall cooling arrangement 88. In the exemplary embodiment shown the mateface purge slot 104 is racetrack shaped, having rounded ends and straight lines there between, because this shape promotes fluid flow. The purge slot 104 may be located directly in the middle of the mateface 36 and above a recess (not shown) where an axial seal pin (if applicable) contacts the blade 10 at a bottom edge of the inner platform 30. The purge slot 104 may be angled in a downstream direction towards a mateface surface of an adjacent blade (not shown). Other mateface purge slot 104 shapes and angular orientations may be utilized if necessary.

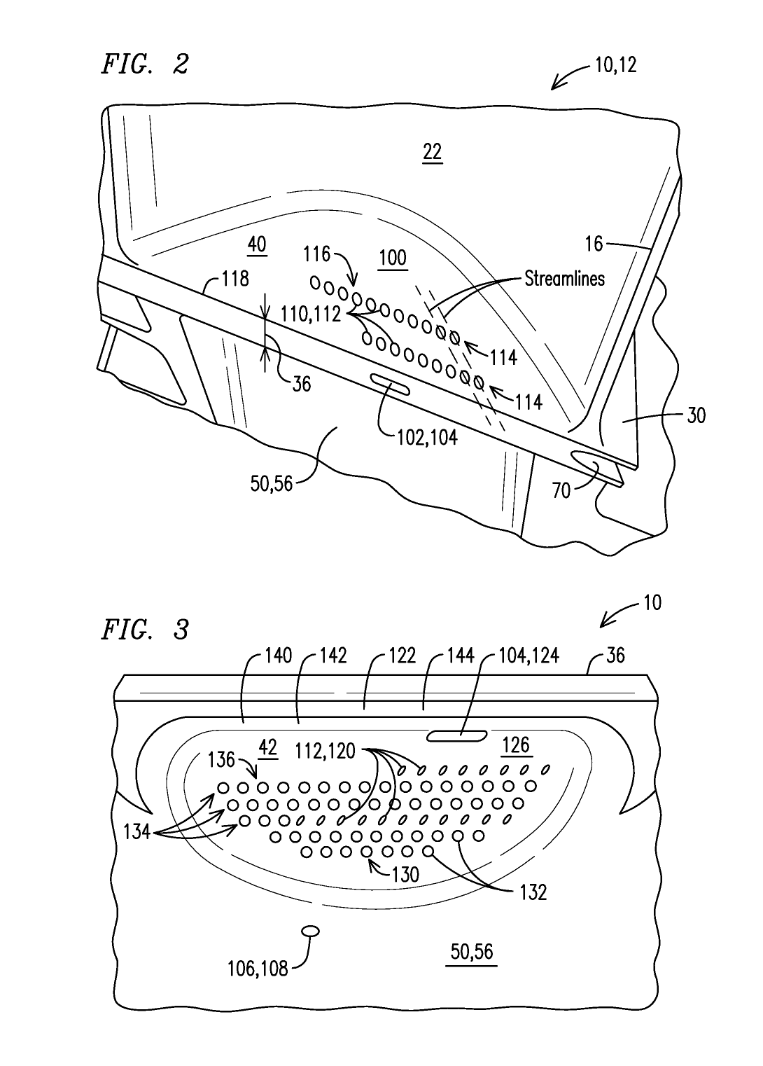

FIG. 2 shows film cooling hole outlets 110 of the film cooling holes 112. The film cooling holes 112 may be arranged in one or more rows 114, where at least one of the rows 114 is oriented parallel to the mateface 36. In an exemplary embodiment shown, the film cooling hole outlets 110 are staggered from each other. The film cooling hole outlets 110 incorporate shaped features to maximize film coverage and cooling of the platform gas path surface 40 as well as a trailing end of a platform of an adjacent blade (not shown). In the exemplary embodiment shown there are twenty film cooling holes 112, but there may be more or fewer as desired. Some or all of the film cooling holes 112 may be uniformly aligned with each other. The film cooling holes 112 may be drilled at an angle to the platform gas path surface 40. In the exemplary embodiment shown the film cooling holes 112 are drilled at thirty degrees, but other angles may be used as desired.

The film cooling hole 112 may be oriented such that cooling fluid flowing therefrom already includes a directional component parallel to the pressure side 22 of the airfoil 12, toward a trailing end of the airfoil proximate the trailing edge 16, which is also parallel to an average streamline of overflowing hot gases, when ejected. When the film cooling holes 112 and the streamline coincide in this manner (as viewed looking radially inward at the platform gas path surface 40 from the tip 20), the ejected cooling fluid is already traveling with the overflowing hot gases. Further, the film cooling holes 112 form a pattern 116 that is positioned to ensure that the film cooling holes 112 penetrate a hottest region (highest temperature region) of the inner platform 30 to ensure cooling is present where most needed. Thus, the film cooling holes 112 form part of a cooling circuit where cooling fluid enters the film cooling holes 112 from below the platform coolant surface 42, flows through the inner platform 30, and exits to form a film layer that protects the platform gas path surface 40. The film may then travel to a platform of an adjacent blade (not shown) and contribute to cooling of its inner platform on a suction side of its airfoil. Cooling fluid may also enter a gap between the inner platform 30 and the adjacent blade, and it may travel toward and cool the trailing edge undercut 70. The cooling effect of the film reduces compressive stress fields created along a corner 118 of the inner platform 30 created from transient operation of the blade 10, which traditionally can lead to cracking of the inner platform 30 and ultimately liberation of the inner platform 30.

FIG. 3 shows the platform coolant surface 42 with film cooling hole inlets 120. It can be seen by the elongated appearance that the film cooling hole inlets 120 may also be shaped to facilitate entry of cooling fluid into the film cooling hole 112. Further, the elongation indicates a direction in which the film cooling holes are oriented and which causes ejected cooling fluid to flow with the hot gases overflowing the film cooling outlets 110 on the platform gas path surface 40. The film cooling hole inlets 120 may be centered on the platform coolant surface 42.

Also visible in FIG. 3 is the mateface 36 which is an outer surface of a mateface wall 122. A mateface purge slot inlet 124 of the mateface purge slot 104 can be seen passing through the mateface wall 122. The mateface wall 122 and the shank pressure side face 56 help define a shank pocket 126 into which cooling fluid flows and from which cooling fluid exits via the film cooling holes 112 and/or the mateface purge slot 104. Thus, in a mateface purge slot circuit, cooling fluid from the shank pocket 126 enters the mateface purge slot 104, traverses the mateface wall 122, and exits through the mateface 36, where it enters a gap between the mateface 36 and a mateface of an adjacent blade. Some of the cooling fluid then may cool the platform of the adjacent blade, and some may travel aft to cool the trailing edge undercut 70.

An array 130 of turbulators 132 is formed into the platform gas path surface 40 to improve cooling. The purpose of the turbulators is to promote and augment the convective heat transfer on the platform coolant surface 42. The array 130 may be configured to provide complete cooling effect coverage of the platform coolant surface 42. The turbulators 132 may be arranged in one or more rows 134, and when multiple rows 134 are used, the rows 134 may be parallel to each other and may be parallel to the mateface 36. Individual turbulators 132 in the rows 134 may be staggered from individual turbulators 132 in immediately adjacent rows. The array 130 may or may not form a repeating pattern 136. A portion of the pattern 136 may or may not be displaced to accommodate film cooling hole inlets 120. Displacing a turbulators 132 may reduce mechanical stresses that might otherwise result from a hole being close to or as part of a turbulator. While the turbulators 132 shown are hemispherical in shape, other shapes may be used as desired. Similarly, the turbulators may form rows that are not parallel, may not form rows, and may not be staggered from each other if they are arranged in rows. Likewise, the turbulators may not form a readily identifiable pattern, but may instead be distributed according to, for example, heat transfer requirements etc.

The increase in heat transfer caused by a removed turbulator is lost, but replaced by increased heat transfer caused by convection of the cooling fluid entering the film cooling hole inlet 120. While the heat transfer increase of the turbulator may not be the exact same as the heat transfer increase of the film cooling hole inlet 120, the substitution of a turbulator 132 with a film cooling hole inlet 120 is acceptable.

Also visible is the shank outlet 106 of the shank cooling hole 108. The shank cooling hole 108 is oriented such that a shank impingement jet supplied by an internal cooling supply channel (not shown) in the shank 50 impinges an impingement location 140 on the mateface wall 122 forward (more toward the platform forward face 32) of the mateface purge slot inlet 124. Alternately, the impingement location 140 may be or may include a lower edge 144 of the mateface wall 122.

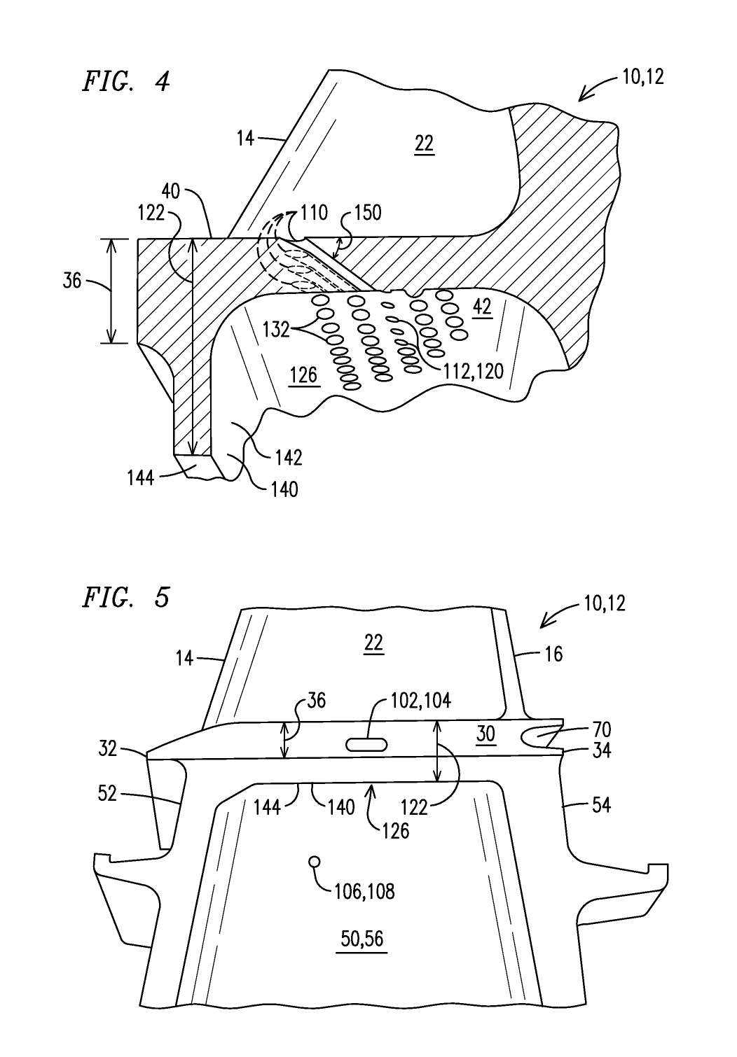

FIG. 4 shows film cooling holes 112 spanning from the platform coolant surface 42 to the platform gas path surface 40 and at an angle 150 of thirty degrees. Other angles may be utilized as desired. The shaping of the film cooling hole outlets 110 is more apparent in this figure and is effective to slow cooling fluid exiting from the film cooling hole 112. This helps the film produced by the film cooling holes to better adhere to and protect the platform gas path surface 40.

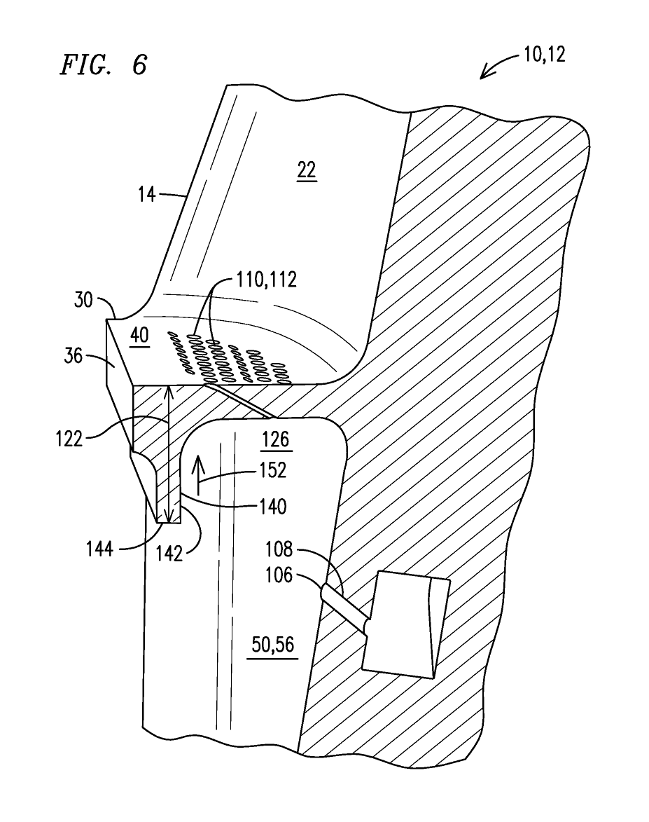

FIG. 5 shows the shank outlet 106 of the shank cooling hole 108, which is vectored so that cooling fluid ejected there from would be directed onto the pocket side 142 of the mateface wall 122 at the impingement location 140. In a mateface wall cooling circuit, after impinging the impingement location 140, spent cooling fluid may flow in a radially outward direction 152 due to blade rotation forces and farther into the shank pocket 126. The directional cooling fluid from the shank cooling hole 108 and the cooling fluid circulating inside the shank pocket 126 (due to rotation effects during operation) may flow across the array 130 of turbulators 132 to promote the convective cooling process of the platform coolant surface 42. Some of the cooling fluid may enter the mateface purge slot 104 and some of the cooling fluid may enter the film cooling holes 112.

FIG. 6 shows the shank outlet 106 of the shank cooling hole 108 and a general indication of the impingement location 140 on the pocket side 142 (not visible) of the mateface wall 122, forward of the mateface purge slot inlet 124 (not visible). In addition, it can be seen that the mateface purge slot 104 is configured to ensure that cooling fluid entering from the shank pocket 126 and then ejected there from fills the gap between the mateface 36 and a mateface of an adjacent blade (not shown). Once ejected, at least a portion of the cooling fluid flows aft toward the trailing edge undercut 70, where it helps cool the trailing edge undercut 70. Filling the gap with cooling fluid also reduces the potential for hot gas ingestion.

Each cooling arrangement disclosed above is effective to cool and therefore extend the service life of the inner platform, and hence the blade, while being easy to manufacture, and hence, less costly to implement. When two or more are used in combination with each other the cooling effect is substantially more effective and hence represents an improvement in the art.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A gas turbine engine blade, comprising:
an airfoil comprising a pressure side and a suction side;
an inner platform, comprising: a gas path surface; a coolant surface; and at least one row of film cooling holes spanning there between and disposed on the pressure side of the airfoil, the film cooling holes angled to comprise a directional component parallel with the pressure side at a trailing end of the airfoil, and the at least one row is oriented parallel to a mateface wall of the inner platform; and
an array of turbulators disposed on the coolant surface.

2. The gas turbine engine blade of claim 1, wherein all of the film cooling holes are uniformly oriented.

3. The gas turbine engine blade of claim 1, wherein outlets of the film cooling holes are disposed in a highest temperature region of the gas path surface.

4. The gas turbine engine blade of claim 1, wherein the array of turbulators comprises at least one row of turbulators oriented parallel to the mateface wall.

5. The gas turbine engine blade of claim 1, wherein a portion of the array of turbulators is displaced to accommodate inlets to the film cooling holes.

6. The gas turbine engine blade of claim 5, wherein the inlets are centered in the array of turbulators.

7. The gas turbine engine blade of claim 4, wherein the array of turbulators comprises at least two rows of turbulators, and wherein the turbulators within adjacent rows are staggered from each other.

8. The gas turbine engine blade of claim 1, further comprising a shank, comprising a shank cooling hole spanning between a mateface of the shank and an internal cooling supply channel within the shank, wherein the shank cooling hole is vectored radially outward so a shank impingement jet emanating there from impinges a pocket side of the mateface wall.

9. The gas turbine engine blade of claim 8, further comprising a mateface purge slot through the mateface wall.

10. The gas turbine engine blade of claim 9, wherein the mateface purge slot comprises straight sides between rounded ends.

11. The gas turbine engine blade of claim 9, wherein the shank impingement jet is vectored to impinge the mateface wall at an impingement location forward of the mateface purge slot.

12. The gas turbine engine blade of claim 11, wherein the impingement location is selected so spent cooling fluid from the shank impingement jet flows radially outward and then across the coolant surface when the gas turbine engine blade is in operation.

13. The gas turbine engine blade of claim 12, wherein the impingement location is selected so spent cooling fluid from the shank impingement jet flows across the coolant surface and into the film cooling holes.

14. The gas turbine engine blade of claim 9, further comprising a trailing edge undercut disposed in and spanning less than an entire width of a shank aft face of the inner platform.

15. The gas turbine engine blade of claim 14, wherein the mateface purge slot is positioned to receive spent cooling fluid from the shank impingement jet and to deliver cooling fluid to the trailing edge undercut when the gas turbine engine blade is in operation.

16. In a gas turbine engine blade comprising: an airfoil comprising a pressure side and a suction side; an inner platform comprising a gas path surface, a coolant surface, and a mateface wall; and a shank; wherein the shank, the coolant surface, and the mateface wall define a shank pocket, an improvement comprising:
at least one row of film cooling holes spanning between the gas path surface and the coolant surface and disposed on a pressure side of the airfoil, wherein the at least one row parallel to the mateface wall;
a shank cooling hole spanning between a mateface of the shank and an internal cooling supply channel within the shank, the shank cooling hole configured to direct a shank impingement jet onto the mateface wall at an impingement location; and
a mateface purge slot through the mateface wall aft of the impingement location,
wherein the gas turbine engine blade is configured such that during operation spent impingement air flows radially outward into the shank pocket, and the shank cooling pocket supplies cooling fluid to the film cooling holes and the mateface purge slot.

17. The gas turbine engine blade of claim 16, further comprising a trailing edge undercut disposed in and spanning less than an entire width of a shank aft face of the inner platform, wherein the gas turbine engine blade is configured such that during operation cooling fluid exiting the shank cooling hole is effective to cool the trailing edge undercut.

18. The gas turbine engine blade of claim 16, further comprising a array of turbulators disposed on the coolant surface.

19. The gas turbine engine blade of claim 16, wherein the film cooling holes are angled to coincide with a streamline of a flow of hot gases flowing past a trailing edge of the airfoil.

20. The gas turbine engine blade of claim 16, wherein all of the film cooling holes are uniformly oriented.
